(19) United States
(12) Patent Application Publication
(10) Pub. No.: US 2022/0101352 A1
(43) Pub. Date: Mar. 31, 2022

(54) SYSTEM AND METHOD FOR AUTOMATED SALES FORECAST ON AGGREGATE LEVEL DURING BLACK SWAN SCENARIO

(71) Applicant: Aviso LTD., Redwood City, CA (US)

(72) Inventors: Joy MUSTAFI, Hyderabad (IN); Sayan Deb KUNDU, Kolkata (US); Trevor RODRIGUES, Scottsdale, AZ (US)

(73) Assignee: Aviso LTD., Redwood City, CA (US)

(21) Appl. No.: 17/039,391

(22) Filed: Sep. 30, 2020

(51) Int. Cl. G06Q 30/02; G06Q 10/04; G06Q 10/10; G06N 20/00; G06F 16/245

(52) U.S. Cl. CPC G06Q 30/0202; G06Q 10/04; G06F 16/245; G06Q 10/107; G06N 20/00; G06Q 10/105

(57) ABSTRACT

The present invention relates to a system (100) and method for automated sales forecast on an aggregate level during the black swan scenario. The present invention includes a computational unit (102), and a display unit (108). In an embodiment, the computational unit (102) including, but limited to, a desktop computer, a laptop, a tablet, a smartphone, a mobile phone. The computational unit (102) includes a database unit (104) and a system processing unit (106). The system processing unit (106) executes computer-readable instructions to collect the company data through the company servers and the system processing unit (106) further executes computer-readable instruction to forecast sales of the company on an aggregate level during the black swan scenario. The system processing unit (106) executes computer-readable instructions to provide a comprehensive analysis of forecasts from the top-down level that serves the basis for the Finance Team/CSO/CFO to set modified targets.

### FIELD OF INVENTION

The present invention relates to an artificial intelligence-based system, and method for sales forecast, and more specifically relates to an artificial intelligence-based platform for automated sales forecast on an aggregate level during the black swan scenario.

Technology is being developed at exponential rates. Human intelligence is increasing linearly but technologies are expanding exponentially. Data science and artificial intelligence are part of exponential technologies. Thus most of the technology has been created using different exponential technologies.

The world is facing different new challenges every year. A slow down in the economy is one of the major challenges in the world. Because of globalization, the economy of every country is dependent on each other. If there is an economic slowdown in one part of the world, that affects the economy of the whole world.

Thus the Economy has become very complex such that it gets affected by different factors. The black swan event is one of the factors that affect the economy very badly. The black swan event reduces buyer confidence thereby clouding a range of sales forecasts where once-predictable portions of the business continue to behave differently. The leading indicators used to inform pre-existing forecast processes (for example, historical load rates, lead/pipeline conversion rates, weighted pipeline) may not be as effective at projecting volume, bookings, and revenue in current conditions Due to black swan event sales of the company drastically get affected. Since black swan events are unpredictable then make it difficult for the company to overcome slow in sales that ultimately affects the company economy.

Though statistics are help full in predicting the overall economy based on the previous data of the black swan event. But there is no such statistics method available to measure economy or sales on the company level. Also studying large data manually and developing useful statistics is time-consuming and difficult. Also, there is a huge probability of error in predicting sales using traditional statistical methods. Because traditional statistical methods take a hit during Black Swan events and the base parameters change drastically.

Patent application CN108876421 discloses a method and system for predicting commodity dynamic sales volume, this method carries out dynamic prediction to Sales Volume of Commodity based on the gray model and Catastrophe Model. This method does not need a large amount of historical data, solves the problems, such as medium-sized and small enterprises data deficiencies, and has very strong adaptability to fluctuation data and the time of exceptional value appearance can be effectively predicted, valuable data reference is provided for enterprise marketing decision. This method includes sales volume of commodity data are acquired, and the Sales Volume of Commodity data are pre-processed, wherein the pretreatment includes the catastrophe data detected in the Sales Volume of Commodity data and rejects the catastrophe data. The corresponding vacancy numerical value of the catastrophe data being removed in Sales Volume of Commodity data described in polishing generates Sales Volume of Commodity data sequence Unbiased grey-forecasting model is constructed using the Sales Volume of Commodity data sequence and carries out Sales Volume of Commodity prediction using the unbiased grey-forecasting model.

The exiting invention does not provide forecasts for anticipated deals on aggregate level amidst Black Swan scenario and dipping consumer sentiments. The exiting invention does not forecast for individual companies. This is within the aforementioned context that a need for the present invention has arisen. Thus, there is a need to address one or more of the foregoing disadvantages of conventional systems and methods, and the present invention meets this need.

### SUMMARY OF THE INVENTION

The present invention relates to a system and method for automated sales forecast on an aggregate level during a black swan scenario. The present invention includes a computational unit and a display unit. In an embodiment, the computational unit including, but limited to, a desktop computer, a laptop, a tablet, a smartphone, a mobile phone. The computational unit includes a database unit and a system processing unit. The database unit stores computer-readable instructions and an artificial intelligence-based model. The system processing unit executes computer-readable instructions and inputs various company data from company servers to execute the top-down analysis. The display unit is connected to the system processing unit of the computational unit and the display unit displays a sales forecast.

Herein, the system processing unit executes computer-readable instructions to collect the company data through the company servers and the system processing unit further executes computer-readable instruction to forecast sales of the company on an aggregate level during the black swan scenario.

In the preferred embodiment, the company data includes a variety of data selected from stock value, finance data, lay off data, revenue, projected growth, CRM data, ERP data, macroeconomic events, emails, and calls data.

In the preferred embodiment, the company data helps to train the artificial intelligence-based model that is further being used by the system processing unit to forecast sales of the company on an aggregate level during the black swan scenario.

In the preferred embodiment, the system processing unit executes computer-readable instructions to provide a comprehensive analysis of forecasts from the top-down level that serves the basis for the Finance Team/CSO/CFO to set modified targets.

The main advantage of the present invention is that the present invention provides a forecast on sales for individual companies.

Yet another advantage of the present invention is that the present invention provides forecasts for anticipated deals at aggregate level amidst the Black Swan scenario and dipping consumer sentiments.

Yet another advantage of the present invention is that the present invention provides a comprehensive analysis of forecasts from the top-down level.

Yet another advantage of the present invention is that the present invention derives insights from news on one company and news convoluted impact on another company.

Yet another advantage of the present invention is that the present invention provides insights on which sectors will go down and which sectors will go up.

Yet another advantage of the present invention is that the present invention serves as a basis for Finance Team/CSO/CFO to set modified targets.

Yet another advantage of the present invention is that the present invention forecast chances of future layoffs or salary cuts.

Further objectives, advantages, and features of the present invention will become apparent from the detailed description provided herein below, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates the system of the present invention.

FIG. 2 illustrates the method of the present invention through a flowchart.

### DETAILED DESCRIPTION OF THE INVENTION

### Definition

The terms “a” or “an”, as used herein, are defined as one or as more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps, or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. The term “means” preceding a present participle of operation indicates the desired function for which there is one or more embodiments, i.e., one or more methods, devices, or apparatuses for achieving the desired function and that one skilled in the art could select from these or their equivalent because of the disclosure herein and use of the term “means” is not intended to be limiting.

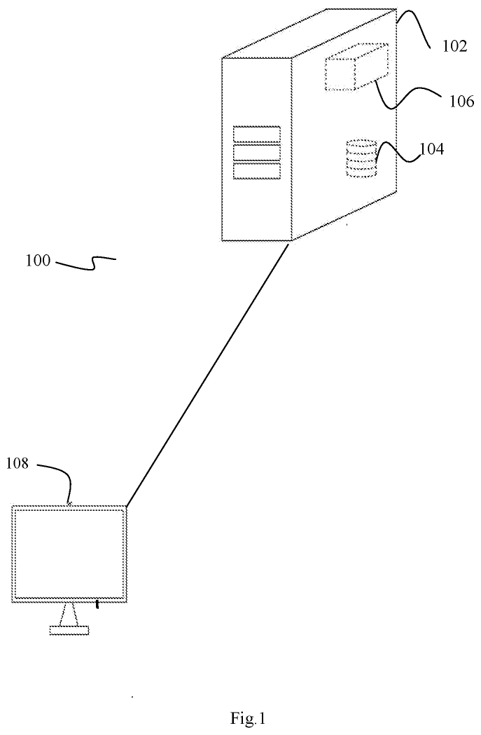

FIG. 1 illustrates a system (100) for sales forecast on an aggregate level during the black swan scenario. The system (100) includes a computational unit (102), and a display unit (108). The computational unit (102) includes a database unit (104) and a system processing unit (106). The database unit (104) stores computer-readable instructions and an artificial intelligence-based model. The system processing unit (106) executes computer-readable instructions and inputs various company data from company servers to execute the top-down analysis. The display unit (108) is connected to the system processing unit (106) of the computational unit (102) and the display unit (108) displays a sales forecast.

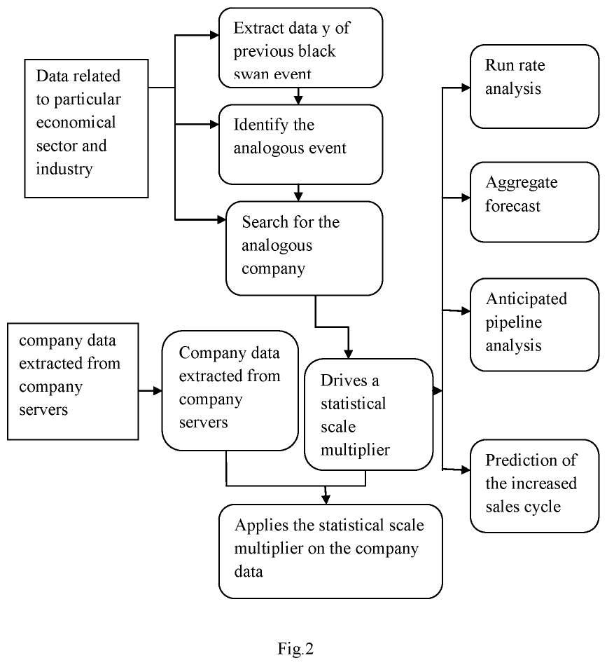

FIG. 2 a method for automated sales forecasts on an aggregate level during the black swan scenario. A system processing unit (106) executes computer-readable instructions to receive data related to particular economic sectors and industries in which the target company, whose sales need to be forecasted, falls. Further, the system processing unit (106) executes computer-readable instructions to extract data related to a plurality of previous black swan event. Further, the system processing unit (106) executes computer-readable instructions to further compare the previous black swan event with the present pandemic situation to identify the analogous event. After the analogous event is identified, the system processing unit (106) executes computer-readable instructions to search for the analogous company whose sales get affected by the analogous event. By using data of analogous events and analogous company, the system processing unit (106) executes computer-readable instructions and drives a statistical scale multiplier. The system processing unit (106) executes computer-readable instructions and applies the statistical scale multiplier on the company data that directly and indirectly impact sales of the company. The system processing unit (106) thus generates the forecast sales of the company on an aggregate level.

The present invention relates to a system and method for automated sales forecast on an aggregate level during black swan scenario. The present invention includes a computational unit and a display unit. In an embodiment, the computational unit including, but limited to, a desktop computer, a laptop, a tablet, a smartphone, a mobile phone. The computational unit includes a database unit and a system processing unit. The database unit stores computer-readable instructions and an artificial intelligence-based model. The system processing unit executes computer-readable instructions and inputs various company data from company servers to execute the top-down analysis. The display unit is connected to the system processing unit of the computational unit and the display unit displays a sales forecast.

Herein, the system processing unit executes computer-readable instructions to collect the company data through the company servers and the system processing unit further executes computer-readable instruction to forecast sales of the company on an aggregate level during the black swan scenario.

In the preferred embodiment, the company data includes a variety of data selected from stock value, finance data, lay off data, revenue, projected growth, CRM data, ERP data, macroeconomic events, emails, and calls data.

In the preferred embodiment, the company data helps to train the artificial intelligence-based model that is further being used by the system processing unit to forecast sales of the company on an aggregate level during the black swan scenario.

In the preferred embodiment, the system processing unit executes computer-readable instructions to provide a comprehensive analysis of forecasts from the top-down level that serves the basis for the Finance Team/CSO/CFO to set modified targets.

In an embodiment, the present invention relates to a system and method for automated sales forecast on an aggregate level during the black swan scenario. The present invention includes one or more computational units and one or more display units. In an embodiment, the one or more computational units including, but limited to, a desktop computer, a laptop, a tablet, a smartphone, a mobile phone. The one or more computational units include one or more database units, and a system processing unit. The one or more database units store computer-readable instructions and an artificial intelligence-based model. The system processing unit executes computer-readable instructions and inputs various company data from company servers to execute the top-down analysis. The one or more display units are connected to the system processing unit of the one or more computational units and the one or more display units display sales forecast.

Herein, the system processing unit executes computer-readable instructions to collect the company data through the company servers and the system processing unit further executes computer-readable instruction to forecast sales of the company on an aggregate level during the black swan scenario.

In the preferred embodiment, the company data includes a variety of data selected from stock value, finance data, lay off data, revenue, projected growth, CRM data, ERP data, macroeconomic events, emails, and calls data.

In the preferred embodiment, the company data helps to train the artificial intelligence-based model that is further being used by the system processing unit to forecast sales of the company on an aggregate level during the black swan scenario.

In the preferred embodiment, the system processing unit executes computer-readable instructions to provide a comprehensive analysis of forecasts from the top-down level that serves the basis for the Finance Team/CSO/CFO to set modified targets.

In an embodiment, the present invention relates to a method for automated sales forecast on an aggregate level during the black swan scenario. The method includes:

A method of gathering data, the method having:
a system processing unit executes computer-readable instructions to receive data related to particular economical sector and industry in which the target company, whose sales need to be forecasted, fall;
further, the system processing unit executes computer-readable instructions to extract data related to a plurality of previous black swan event,
further, the system processing unit executes computer-readable instructions to further compare the previous black swan event with the present pandemic situation to identify the analogous event;
after the analogous event is identified, the system processing unit executes computer-readable instructions to search for the analogous company whose sales get affected by the analogous event; and

Company data that directly and indirectly impact sales of the company is being extracted from company servers and is transferred to the system processing unit of a computational unit.

A method of analyzing data and forecasting sales on an aggregate level, the method having:
by using data of analogous events and analogous company, the system processing unit executes computer-readable instructions and drives a statistical scale multiplier;
the system processing unit executes computer-readable instructions and applies the statistical scale multiplier on the company data that directly and indirectly impact sales of the company; and
the system processing unit thus generates the forecast sales of the company on an aggregate level.

In an embodiment, the system processing unit executes computer-readable instructions to forecast run rate analysis, aggregate forecast, and anticipated pipeline analysis and prediction of the increased sales cycle.

In an embodiment, the company data, that are being utilized to forecast sales of the company on an aggregate level are selected from a stock value, finance data, lay off data, revenue, projected growth, CRM data, ERP data, macroeconomic events, emails and calls data.

In an embodiment, wherein different statistical scale multipliers are being used to forecast different parameters that further help to forecast sales of the company on an aggregate level.

In an embodiment, the present invention relates to a method for automated sales forecast on an aggregate level during the black swan scenario. The method includes:

A method of gathering data, the method having:
a system processing unit executes computer-readable instructions to receive data related to particular economical sector and industry in which the target company, whose sales need to be forecasted, falls;
further, the system processing unit executes computer-readable instructions to extract data related to a plurality of previous black swan event,
further, the system processing unit executes computer-readable instructions to further compare the previous black swan event with the present pandemic situation to identify the analogous event;
after the analogous event is identified, the system processing unit executes computer-readable instructions to search for the analogous company whose sales get affected by the analogous event; and
company data that directly and indirectly impact sales of the company is being extracted from company servers and are transferred to the system processing unit of one or more computational units.

A method of analyzing data and forecasting sales on an aggregate level, the method having:
by using data of analogous events and analogous company, the system processing unit executes computer-readable instructions and drives a statistical scale multiplier;
the system processing unit executes computer-readable instructions and applies the statistical scale multiplier on the company data that directly and indirectly impact sales of the company; and
the system processing unit thus generates the forecast sales of the company on an aggregate level.

In an embodiment, the system processing unit executes computer-readable instructions to forecast run rate analysis, aggregate forecast, and anticipated pipeline analysis and prediction of the increased sales cycle.

In an embodiment, the company data, that are being utilized to forecast sales of the company on an aggregate level are selected from a stock value, finance data, lay off data, revenue, projected growth, CRM data, ERP data, macroeconomic events, emails and calls data.

In an embodiment, wherein different statistical scale multipliers are being used to forecast different parameters that further help to forecast sales of the company on an aggregate level.

Further objectives, advantages, and features of the present invention will become apparent from the detailed description provided herein, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

I/We claim:

1. A system and method for automated sales forecast on an aggregate level during the black swan scenario, the system comprising:
an at least one computational unit, the at least one computational unit having
an at least one database unit, the at least one database unit stores computer-readable instructions and an artificial intelligence-based model, and
a system processing unit, the system processing unit executes computer-readable instructions and inputs various company data from company servers to execute top-down analysis;
an at least one display unit, the at least one display unit is connected to the system processing unit of the at least computational unit and the at least one display unit displays sales forecast;
wherein, the system processing unit executes computer-readable instructions to collect the company data through the company servers and the system processing unit further executes computer-readable instruction to forecast sales of the company on an aggregate level during the black swan scenario.

2. The system as claimed in claim 1, wherein the at least computational unit is selected from a desktop computer, a laptop, a tablet, a smartphone, a mobile phone.

3. The company data as claimed in claim 1, wherein the company data includes a variety of data selected from stock value, finance data, lay off data, revenue, projected growth, CRM data, ERP data, macroeconomic events, emails, and calls data.

4. The company data as claimed in claim 1, wherein the company data helps to train the artificial intelligence-based model that is further being used by the system processing unit to forecast sales of the company on an aggregate level during the black swan scenario.

5. The system as claimed in claim 1, wherein the system processing unit executes computer-readable instructions to provide a comprehensive analysis of forecasts from the top-down level that serves the basis for the Finance Team/CSO/CFO to set modified targets.

6. A method for automated sales forecast on an aggregate level during the black swan scenario, the method comprising:
a method of gathering data, the method having
a system processing unit executes computer-readable instructions to receive data related to particular economical sector and industry in which the target company, whose sales need to be forecasted, falls;
further, the system processing unit executes computer-readable instructions to extract data related to a plurality of previous black swan event,
further, the system processing unit executes computer-readable instructions to further compare previous black swan event with the present pandemic situation to identify the analogous event,
after the analogous event is identified, the system processing unit executes computer-readable instructions to search for the analogous company whose sales get affected by the analogous event, and
company data that directly and indirectly impact sales of the company is being extracted from company servers and are transferred to the system processing unit of the at least one computational unit;
a method of analysing data and forecasting sales on an aggregate level, the method having by using data of analogous events and analogous company, the system processing unit executes computer-readable instructions and drives a statistical scale multiplier,
the system processing unit executes computer-readable instructions and applies the statistical scale multiplier on the company data that directly and indirectly impact sales of the company, and
the system processing unit thus generates the forecast sales of the company on an aggregate level.

7. As claimed in claim 6, wherein, the system processing unit executes computer-readable instructions to forecast run rate analysis, aggregate forecast, and anticipated pipeline analysis and prediction of the increased sales cycle.

8. The method as claimed in claim 6, wherein the company data, that are being utilized to forecast sales of the company on an aggregate level, are selected from a stock value, finance data, lay off data, revenue, projected growth, CRM data, ERP data, macroeconomic events, emails and calls data.

9. The method as claimed in claim 6, wherein different statistical scale multipliers are being used to forecast different parameters that further help to forecast sales of the company on an aggregate level.
